(19) United States
(12) Patent Application Publication
(10) Pub. No.: US 2023/0391361 A1
(43) Pub. Date: Dec. 7, 2023

(54) AUTONOMOUS DRIVING VEHICLE AND METHOD FOR CHARGING BATTERY OF AUTONOMOUS DRIVING VEHICLE

(71) Applicant: TOYOTA JIDOSHA KABUSHIKI KAISHA, Toyota-shi (JP)

(72) Inventors: Taizo MASUDA, Yokohama-shi (JP); Taro HASEGAWA, Toyota-shi (JP); Tomoya TAKEDA, Toyota-shi (JP); Yuka NISHIYAMA, Toyota-shi (JP); Hiroya CHIBA, Fuji-shi (JP); Tatsuya SUGANO, Sunto-gun (JP); Shun OTA, Susono-shi (JP)

(73) Assignee: TOYOTA JIDOSHA KABUSHIKI KAISHA, Toyota-shi (JP)

(21) Appl. No.: 18/187,896

(22) Filed: Mar. 22, 2023

(30) Foreign Application Priority Data
Jun. 1, 2022 (JP) 2022-089717

(51) Int. Cl. B60W 60/00; B60W 40/02; B60L 8/00

(52) U.S. Cl. CPC B60W 60/001; B60W 40/02; B60L 8/003; B60W 2555/20

(57) ABSTRACT

The autonomous driving vehicle of the present disclosure is equipped with a solar cell and a battery capable of charging electric power generated by the solar cell. The autonomous driving vehicle of the present disclosure searches for a solar power generation point in which the charge power amount of the battery increases more than the current location, and moves to the solar power generation point in the autonomous driving.

### CROSS-REFERENCE TO RELATED APPLICATION

This application claims priority to Japanese Patent Application No. 2022-089717 filed on Jun. 1, 2022, incorporated herein by reference in its entirety.

### BACKGROUND

### 1. Technical Field

The present disclosure relates to an autonomous driving vehicle equipped with a solar cell and a battery that is able to charge power generated by the solar cell, and a method of charging the battery of the autonomous driving vehicle.

### 2. Description of Related Art

Japanese Unexamined Patent Application Publication No. 2018-121395 (JP 2018-121395 A) discloses a vehicle equipped with a solar panel. The vehicle disclosed in JP 2018-121395 A determines, based on a parking position and current date and time, a direction of the solar panel in which it is predicted that a total power generation amount within a predetermined period is maximized when the vehicle is parked for the period. Then, the posture of the vehicle is controlled according to the parking direction by using a suspension device such that the solar panel faces in the determined direction.

### SUMMARY

Nowadays, in order to promote energy conservation in society as a whole, it is required to increase the use of power generated by sunlight in a vehicle. Performing solar power generation in a parked vehicle as described in JP 2018-121395 A is one method of effectively utilizing the sunlight. However, when the vehicle is parked at a position where the sunlight is not applied, power generation by the sunlight cannot be performed regardless of how the direction of the solar panel is changed.

The present disclosure has been made in view of the above-described issues. An object of the present disclosure is to promote energy conservation by increasing the use of the power generated by the sunlight in the vehicle.

The present disclosure provides an autonomous driving vehicle for achieving the above object. The autonomous driving vehicle according to the present disclosure is equipped with a solar cell and a battery that is able to charge power generated by the solar cell. The autonomous driving vehicle according to the present disclosure is configured to execute:
searching for a solar power generation point at which an amount of power for charging the battery is increased relative to a current location; and
moving to the solar power generation point by autonomous driving.

According to such a configuration, the use of the power generated by the sunlight in the autonomous driving vehicle can be increased, and the energy conservation can be promoted.

The autonomous driving vehicle according to the present disclosure may be configured to execute determining the solar power generation point based on a weather forecast of a surrounding region. By using the weather forecast, a location suitable for the solar power generation is predicted, and the vehicle can be moved.

The autonomous driving vehicle according to the present disclosure may be configured to execute determining a location where illuminance detected by an illuminance sensor is higher than a surrounding area as the solar power generation point. By using the illuminance sensor, the vehicle can automatically search for a location suitable for the solar power generation while moving in the vicinity of the vehicle.

The autonomous driving vehicle according to the present disclosure may be configured to execute determining the solar power generation point based on an illuminance database in which illuminance data for each time and location is accumulated. By using the illuminance database in which past achievements are accumulated, a location suitable for the solar power generation can be predicted, and the vehicle can be moved.

The autonomous driving vehicle according to the present disclosure may be configured to execute:
identifying unshaded locations based on three dimensional map data, and date and time; and
determining the solar power generation point from among the unshaded locations. The size of a building can be seen from the three dimensional map data, and the position of the sun can be seen from the date and time. Therefore, it is possible to accurately predict the unshaded locations suitable for the solar power generation point.

The autonomous driving vehicle according to the present disclosure may be configured to execute:
calculating a power generation amount by the solar cell per predetermined time for each of registered locations;
calculating a power consumption amount consumed by movement of the autonomous driving vehicle for each of the registered locations; and
determining the solar power generation point from among the registered locations based on a difference between the power generation amount and the power consumption amount for each of the registered locations. By calculating the power consumption amount required for the movement, it is possible to determine whether the determined solar power generation point is a point where an advantage of moving the vehicle can be obtained by the solar power generation.

The autonomous driving vehicle according to the present disclosure may be configured to execute automatic cleaning on at least a panel of the solar cell before moving to the solar power generation point. By cleaning the panel of the solar cell to remove dirt, the amount of power generation can be increased. Preferably, by washing the panel of the solar cell with water, the temperature of the solar cell is reduced, and the amount of power generation can be further increased.

Further, the present disclosure also provides a method for charging a battery of an autonomous driving vehicle equipped with a solar cell. The method for charging the battery includes:
searching for a solar power generation point at which an amount of power for charging the battery is increased relative to a current location of the autonomous driving vehicle; and
moving the autonomous driving vehicle to the solar power generation point by autonomous driving. According to the method for charging the battery as described above, the use of the power generated by the sunlight in the autonomous driving vehicle can be increased, and the energy conservation can be promoted.

As described above, with the autonomous driving vehicle and the method for charging the battery of the autonomous driving vehicle according to the present disclosure, the energy conservation can be promoted by increasing the use of the power generated by the sunlight in the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram illustrating a system configuration of an autonomous driving vehicle according to an embodiment of the present disclosure;

FIG. 2 is a diagram for explaining a method of charging a battery executed in the autonomous driving vehicle shown in FIG. 1;

FIG. 3 is a diagram for explaining a method of charging a battery executed in the autonomous driving vehicle shown in FIG. 1;

FIG. 4A is an example of a diagram for explaining a method of charging a battery executed in the autonomous driving vehicle shown in FIG. 1;

FIG. 4B is an example of a diagram for explaining a method of charging a battery executed in the autonomous driving vehicle shown in FIG. 1;

FIG. 4C is an example of a diagram for explaining a method of charging a battery executed in the autonomous driving vehicle shown in FIG. 1;

FIG. 5 is a diagram for explaining a method of charging a battery executed in the autonomous driving vehicle shown in FIG. 1;

FIG. 6 is a diagram for explaining how to charge the battery executed in the autonomous driving vehicles shown in FIG. 1.

### DETAILED DESCRIPTION OF EMBODIMENTS

Hereinafter, an autonomous driving vehicle and a method of charging a battery executed by the autonomous driving vehicle according to an embodiment of the present disclosure will be described with reference to the drawings.

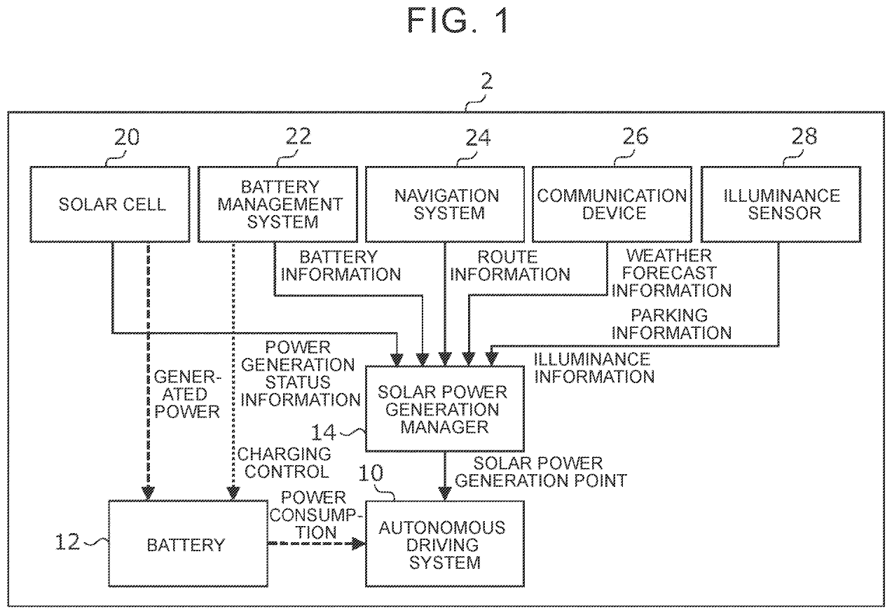

FIG. 1 shows a system configuration of an autonomous driving vehicle 2 according to the present embodiment. The autonomous driving vehicle 2 includes an autonomous driving system 10 capable of autonomously traveling at a level of 4 or higher as defined in U.S. Society of Automotive Engineers (SAE). The autonomous driving system 10 includes an external sensor such as a camera or a LiDAR that recognizes a surrounding state of the vehicle, a vehicle state sensor that detects a vehicle state such as an acceleration/yaw rate, and one or a plurality of ECU that process the information of the sensors to generate a target trajectory of the vehicle. Since the configuration and function of the autonomous driving system are well known and known ones can be applied to the autonomous driving vehicle 2, detailed description of the autonomous driving system 10 will be omitted.

The autonomous driving vehicles 2 are battery electric vehicle (BEV) traveling by electric power stored in the battery 12. The autonomous driving vehicles 2 may be not only battery electrified vehicle (BEV) but also plug-in hybrid electric vehicle (PHEV) or hybrid electric vehicle (HEV). Hereinafter, the autonomous driving vehicle 2 is simply referred to as a vehicle 2.

The vehicle 2 includes a solar cell 20 for generating electric power stored in the battery 12. The solar cell 20 is mounted on a roof of the vehicle 2. The solar cell 20 may also be mounted on a bonnet or trunk. Charging of the battery 12 is performed by, in addition to solar power generation by the solar cell 20, charging by an external charging device, power generation by an internal combustion engine, or power regeneration by regenerative braking. In order to control the charge of the battery 12, the vehicle 2 includes a battery management system 22.

The vehicle 2 includes a navigation system 24, a communication device 26, and an illuminance sensor 28. Navigation system 24 calculates a route to the set destination based on the map data. The communication device 26 communicates with the outside of the vehicle using mobile communication. The information obtained from the outside by the communication device 26 includes weather forecast information. The illuminance sensor 28 measures the illuminance around the vehicle 2. The illuminance sensor 28 may be mounted on a camera for autonomous driving.

The vehicle 2 comprises a solar power generation manager 14. The solar power generation manager 14 is a computer that manages solar power generation using the solar cell 20. For example, the solar power generation manager 14 is configured by one or more ECU. The solar power generation manager 14 acquires power generation state information from the solar cell 20. The solar power generation manager 14 is configured to obtain battery data from battery management system 22. The solar power generation manager 14 has a function of acquiring route information from navigation system 24 to the destination, a function of acquiring weather forecast information and parking lot information using the communication device 26, and a function of acquiring illuminance information using the illuminance sensor 28.

When SOC of the battery 12 is free, the solar power generation manager 14 is programmed to increase SOC of the battery 12 by charging by solar power generation. Specifically, the solar power generation manager 14 is programmed to search for a place where the amount of charged electric power of the battery 12 increases more than the current position of the vehicle 2, and designate the place as a solar power generation point. Further, the solar power generation manager 14 is programmed to send a designated solar power generation point to the autonomous driving system 10 and instruct the autonomous driving system 10 to move the vehicle 2 to the solar power generation point.

When the autonomous driving system 10 moves the vehicle 2 to the solar power generation point by autonomous driving, the amount of electric power charged by the solar cell 20 to the battery 12 can be increased as compared with the case where the autonomous driving system 10 does not move the vehicle 2. However, the effect can be obtained only when the solar power generation point can be appropriately determined. Hereinafter, a method of charging a battery executed by the vehicle 2 according to a method of determining a solar power generation point will be described.

### First Example

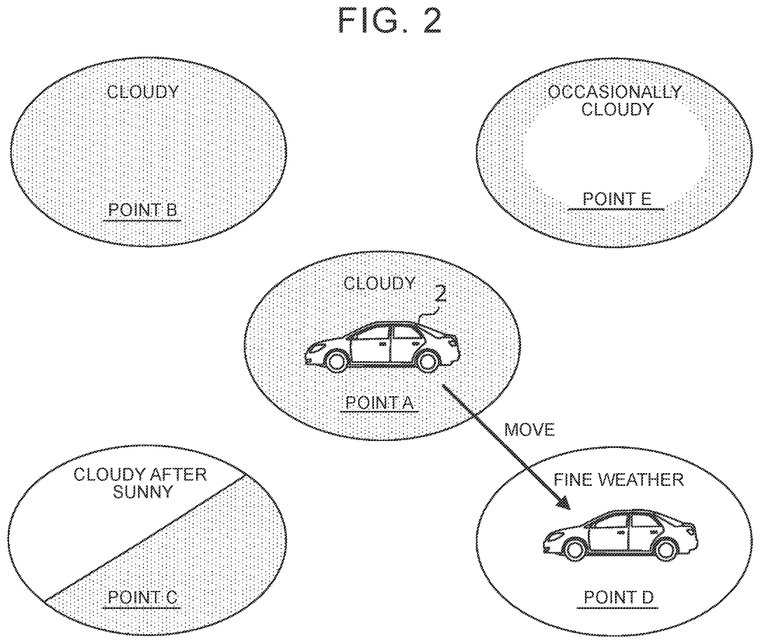

The first example is an example in which the vehicle 2 is moved to a place where a power generation amount higher than the current position can be expected based on the weather forecast information. For example, as shown in FIG. 2, it is assumed that the forecast of the weather at the place (point A) where the vehicle 2 is stopped at the time of the previous day or the morning of the day is cloudy. In this case, even if the vehicle 2 is continuously parked at the point A due to a shortage of sunlight that hits the solar cell 20, the power generation amount by the solar power generation does not increase very much.

Therefore, the solar power generation manager 14 checks the weather of another place based on the weather forecast information obtained by the communication device 26. The place where the weather is examined by the solar power generation manager 14 is a parking lot where the vehicle 2 can be parked in the daytime. In the example shown in FIG. 2, there are four parking lots (points B, C, D, E) approximately equidistant from point A. According to the weather forecast, the future weather at point B is cloudy, the future weather at point C is cloudy, the future weather at point D is clear, and the future weather at point E is cloudy from time to time. By using the weather forecast in this way, it is possible to search for a place suitable for solar power generation in a remote place.

The solar power generation manager 14 determines the best weather point D among the four neighboring points B, C, D, and E as a new solar power generation point. Point D is the place where the strongest sunlight among the four points B, C, D, and E can be expected for the longest time. When a new solar power generation point is set, the autonomous driving system 10 moves the vehicle 2 toward the solar power generation point. As a result, the amount of electric power charged in the battery 12 by the solar power generation can be increased as compared with the case where the vehicle 2 is continuously parked in the place. As a result, the use of the electric power generated by the sunlight in the vehicle 2 is increased, and the energy saving can be promoted.

It should be noted that the weather forecast information used by the solar power generation manager 14 is preferably divided into meshes as fine as possible. For example, weather forecast data divided into meshes with a spacing of a few km, preferably less than or equal to 1 km, is used. It is also possible to use information of rain cloud radar as weather forecast information. In this case, the solar power generation manager 14 moves the vehicle 2 to a place where rain clouds do not occur.

In determining a new solar power generation point, it is searched whether or not there is a vacancy in a parking lot to which the vehicle 2 is to be moved. Based on the parking lot information obtained by the communication device 26, the solar power generation manager 14 checks the vacancy of the parking lot. The parking lot information may be provided by a dedicated parking lot search server, or may be provided by a vehicle management server that manages a group of autonomous driving vehicles including the vehicle 2. When the parking lot to which the vehicle 2 moves is charged, the solar power generation manager 14 calculates a power generation amount that is expected to increase in comparison with the case where the vehicle 2 moves to the parking lot and remains at the current location. If the power generation amount that is expected to increase is converted into an electric charge exceeds the parking charge, the solar power generation manager 14 determines the parking lot as a new solar power generation point.

### Second Example

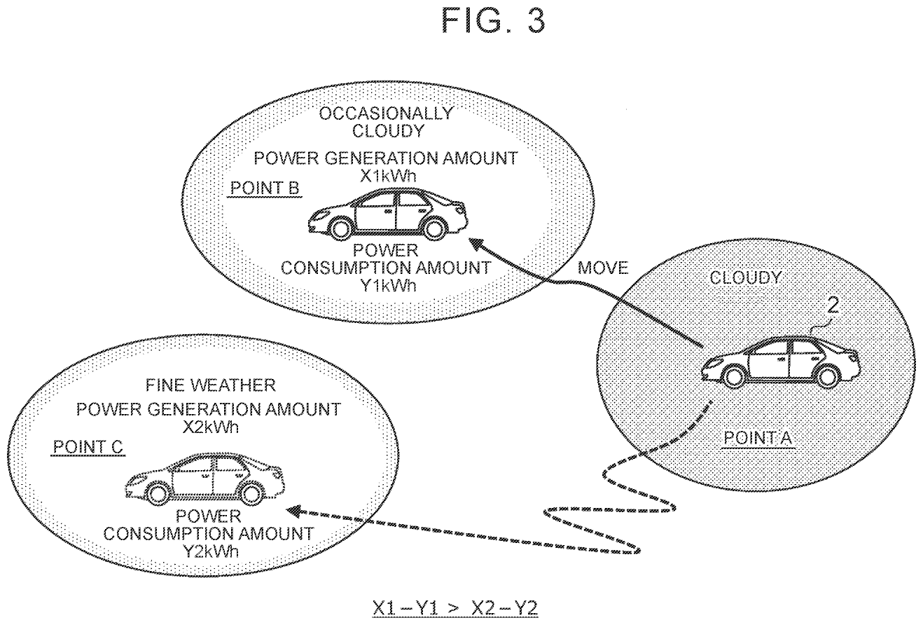

The second example is an example in which the vehicle 2 is moved in order to obtain a place where a power generation amount higher than the current position can be expected, taking into consideration the power consumption amount accompanying the movement. Movement of the vehicle 2 is performed by electric power stored in the battery 12. In the example illustrated in FIG. 3, it is assumed that the forecast of the weather at the place (point A) where the vehicle 2 is stopped at the time of the previous day or the morning of the current day is cloudy.

Based on the weather forecast information obtained by the communication device 26, the solar power generation manager 14 examines the weather in other locations. As a result of the investigation, it was found that the weather at point B was clear and occasionally cloudy, and the weather at point C was clear all day. In this case, the solar power generation point at which the vehicle 2 is to be moved becomes the point C unless the power consumption accompanying the movement is considered. However, depending on the path from the point A, there is a difference in the amount of electric power consumed by the vehicle 2.

Here, it is assumed that the power generation amount expected at the point B is X1 kWh, and the power generation amount expected at the point C is X2 kWh. Further, it is assumed that the power consumption amount predicted by the movement from the point A to the point B is Y1 kWh, and the power consumption amount predicted by the movement from the point A to the point C is Y2 kWh. Power consumption amount is calculated based on the latest electricity cost and the distance on the map. Since the weather is better at point C, the power generation amount at point C is larger than the power generation amount at point B. That is, X2>X1. However, since the distance from the point A is longer at the point C than at the point B, the power consumption amount at the point C is larger than the amount of power consumed at the point C. That is, Y2>Y1.

Whether the point C or the point B is selected as a new solar power generation point is determined by the difference between the power generation amount and the power consumption amount. As shown in FIG. 3, point B is selected as a new solar power generation point if it is a X2-Y2>X1-−Y1. That is, even if the power generation amount expected from the weather forecast is relatively small, in a case where the power consumption amount until moving to the place is relatively small, a place other than the place where the weather is best may be determined as the solar power generation point.

However, depending on the distance between the point B and the point C from the point A, the power consumption amount at both the point B and the point C may exceed the power generation amount. In this case, there is no advantage in moving the vehicle 2. Therefore, when there is no place where a power generation amount exceeding the power consumption amount can be expected, the solar power generation manager 14 maintains the solar power generation point at the point A. By taking into account the power consumption amount required for the movement, it is possible to determine whether or not the merit of moving the vehicle 2 is a place obtained by solar power generation.

### Third Example

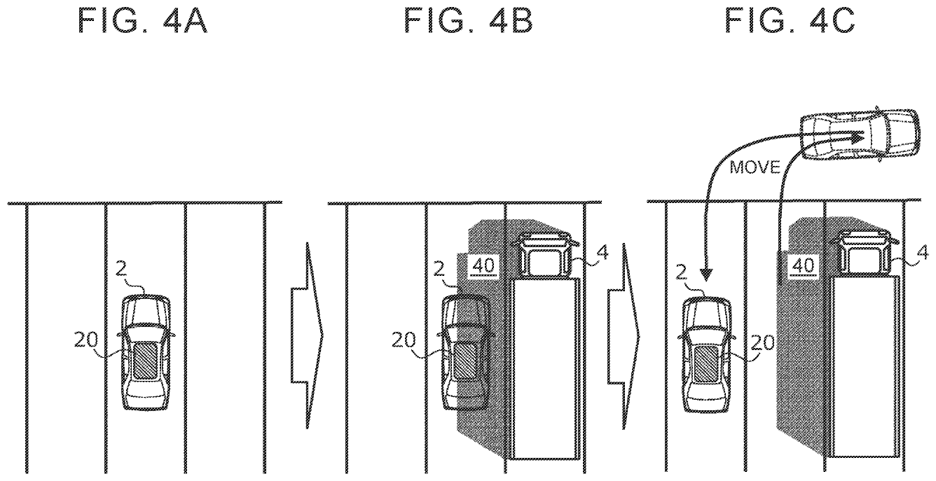

The third example is an example of moving the vehicle 2 in a parking lot for a good place per day. As shown in FIG. 4A, when the vehicle enters the parking lot, the solar power generation manager 14 selects a parking frame that does not enter the shadow of another object and causes the vehicle 2 to park. Which parking frame is good per day can be determined based on the illuminance information obtained from the illuminance sensor 28. The selected parking frame is set as an initial position of the solar power generation point.

However, the situation in which the vehicle 2 is placed changes from the point in time when the vehicle 2 is parked, and a good state per day does not necessarily continue. For example, as shown in FIG. 4B, the large truck 4 may be parked in a parking frame next to the vehicles 2. Since the vehicle height of the large truck 4 is higher than that of the vehicle 2, depending on the direction of the sun, the vehicle 2 enters the shadow 40 created by the large truck 4. Since the vehicle 2 enters the shadow 40 and no sunlight is applied to the solar cell 20, the power generation voltage generated by the solar power generation decreases.

The solar power generation manager 14 recognizes that the vehicle 2 has entered the shadow 40 from the power generation state information obtained from the solar cell 20. For example, if the generated voltage drops rapidly and the state continues for a certain period of time, it can be determined that the vehicle 2 has entered the shadow of some object. The generated voltage of the solar cell 20 also decreases when the sun is temporarily hidden by clouds. However, whether the decrease in the power generation voltage is temporary due to clouds or the vehicle 2 is hidden behind an object can be determined from the state of the change in the power generation voltage. Whether or not the vehicle 2 has entered the shadow 40 can be determined from the illuminance information obtained from the illuminance sensor 28.

When the vehicle 2 enters the shadow 40 and the power generation voltage of the solar cell 20 decreases, the solar power generation manager 14 searches for a new solar power generation point. The new solar power generation point is a place where the distance traveled from the current place is the shortest among places where sunlight can be applied to the solar cell 20. A place where sunlight can be applied to the solar cell 20 can be determined based on illuminance information obtained from the illuminance sensor 28. The reason why the location with the shortest travel distance is selected is to minimize the energy consumption for the travel.

In the embodiment shown in FIG. 4C, the parking frame next to the present parking frame is empty, so that the solar power generation manager 14 determines the parking frame as a new solar power generation point. When a new solar power generation point is set, the autonomous driving system 10 moves the vehicle 2 toward the solar power generation point. As a result, sunlight can continue to be applied to the solar cell 20, and the amount of electric power charged in the battery 12 by solar power generation can be increased. As a result, the use of the electric power generated by the sunlight in the vehicle 2 is increased, and the energy saving can be promoted.

### Fourth Example

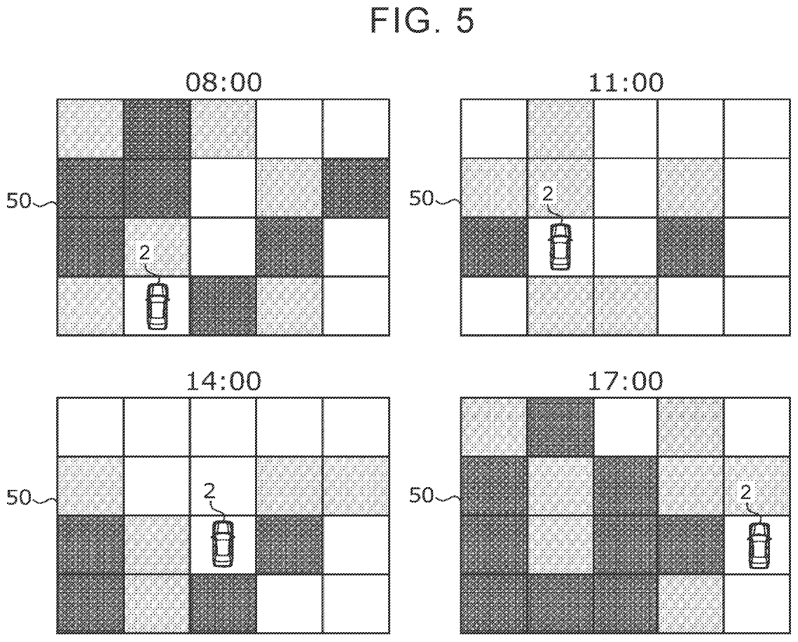

The fourth example is an example of determining a place where the vehicle 2 is moved based on the illuminance database 50 in which the illuminance data for each time place is accumulated. FIG. 5 shows an image of the illuminance database 50. In FIG. 5, a dark mass indicates a place where the illuminance is low, and a light mass indicates a place where the illuminance is high. In the example illustrated in FIG. 5, illuminance data at 8:00, 11:00, 14:00, and 17:00 at 20 locations registered in advance are accumulated in the illuminance database 50.

The illuminance data may be data obtained by an illuminance sensor installed at each location or data obtained by an illuminance sensor included in a vehicle. The illuminance database 50 is constructed in a vehicle management server that manages a plurality of autonomous driving vehicles. The autonomous driving vehicle transmits the position information acquired by GPS and the illuminance data acquired by the illuminance sensor to the vehicle managing server. The vehicle management server accumulates the illuminance data sent from each autonomous driving vehicle in the illuminance database 50.

The solar power generation manager 14 accesses the illuminance database at predetermined time intervals. Then, based on the illuminance data at the future time than the current time, it is determined whether or not the vehicle 2 should be moved and, if so, which place should be determined as a new solar power generation point. Specifically, when the illuminance data indicates that the illuminance at the current location decreases at the next registration time, the solar power generation manager 14 determines the location closest to the current location among the locations where the illuminance is maintained as the new solar power generation point. As described above, by using the illuminance database in which past results are accumulated, it is possible to predict a place suitable for solar power generation and move the vehicle 2.

### Fifth Example

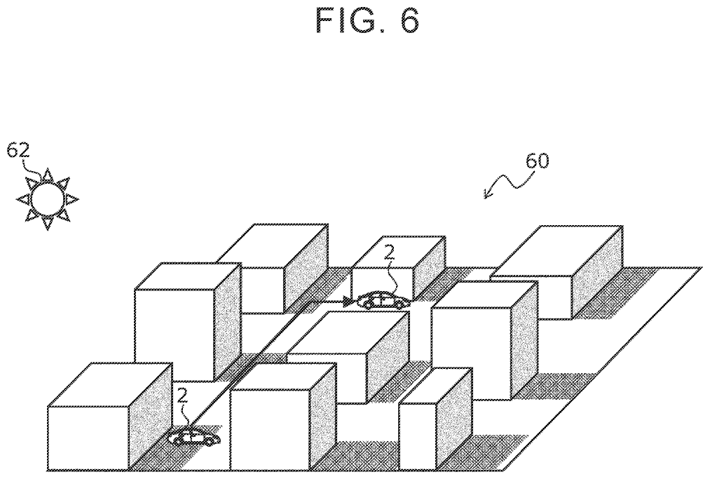

The fifth example is an example of determining a location where the vehicles 2 are moved based on 3D map data and the date and time. FIG. 6 shows images of 3D map-data 60 and the sun model 62. 3D map data 60 includes data on the topography and the height of the building. The sun model 62 is a model that links the date and time and the position of the sun. 3D map data 60 combined with the sun model 62 can be simulated to determine where in the plan view is a shaded place or a non-shaded place.

The solar power generation manager 14 may perform a simulation using 3D map data 60 and the solar model 62 by itself, or may receive a simulation performed by the vehicle-management-server. The solar power generation manager 14 identifies a non-shaded parking lot among the parking lots in which the vehicle 2 can be parked, and determines a solar power generation point from the non-shaded parking lot. Since the size of the building is known from 3D map data 60 and the position of the sun is known from the sun model 62, it is possible to accurately predict a non-shaded area suitable for solar power generation and move the vehicles 2.

### Modified Examples

It is also applicable to the third example, the fourth example, and the fifth example to move the vehicle 2 in search of a place where the power generation amount higher than the current position can be expected, taking into consideration the power consumption amount accompanying the movement described in the second example. Also, moving the vehicle 2 only when it is worth moving even in consideration of the parking fee described in the first example can be applied to the second example, the third example, the fourth example, and the fifth example.

The process of determining the solar power generation point at which the vehicle 2 is to be parked may be performed by the vehicle management server. That is, in the above-described embodiment, the function of the solar power generation manager 14 provided in the vehicle 2 may be transferred to a vehicle management server connected to the vehicle 2 via a network, and the vehicle 2 may be moved in accordance with an instruction from the vehicle management server. In addition, when the vehicle 2 is connected to the user's terminal, the user's terminal may instruct the vehicle 2 to provide a solar power generation point at which the vehicle 2 should be parked.

When the vehicle 2 is moved to the solar power generation point, the vehicle 2 may be moved from the automatic car washing machine to the solar power generation point. By applying the vehicle 2 to the automatic car washing machine, it is possible to remove dirt from the panel of the solar cell 20 and reduce the temperature of the solar cell 20. Thus, the vehicle 2 can be moved to the solar power generation point in a state in which the power generation efficiency of the solar cell 20 is increased. Further, a wiper for wiping the panel of the solar cell 20 may be provided in the vehicle 2, and the panel of the solar cell 20 may be wiped by the wiper before the vehicle 2 moves to the solar power generation point. Since the roof of the vehicle 2 is easily dirty, the effect of improving the power generation efficiency of the solar cell 20 can be expected only by wiping the panel with a wiper.

What is claimed is:

1. An autonomous driving vehicle equipped with a solar cell and a battery that is able to charge power generated by the solar cell, wherein the autonomous driving vehicle is configured to execute:
searching for a solar power generation point at which an amount of power for charging the battery is increased relative to a current location; and
moving to the solar power generation point by autonomous driving.

2. The autonomous driving vehicle according to claim 1, wherein the autonomous driving vehicle is configured to execute determining the solar power generation point based on a weather forecast of a surrounding region.

3. The autonomous driving vehicle according to claim 1, wherein the autonomous driving vehicle is configured to execute determining a location where illuminance detected by an illuminance sensor is higher than a surrounding area as the solar power generation point.

4. The autonomous driving vehicle according to claim 1, wherein the autonomous driving vehicle is configured to execute determining the solar power generation point based on an illuminance database in which illuminance data for each time and location is accumulated.

5. The autonomous driving vehicle according to claim 1, wherein the autonomous driving vehicle is configured to execute:
identifying unshaded locations based on three dimensional map data, and date and time; and
determining the solar power generation point from among the unshaded locations.

6. The autonomous driving vehicle according to claim 1, wherein the autonomous driving vehicle is configured to execute:
calculating a power generation amount by the solar cell per predetermined time for each of registered locations;
calculating a power consumption amount consumed by movement of the autonomous driving vehicle for each of the registered locations; and
determining the solar power generation point from among the registered locations based on a difference between the power generation amount and the power consumption amount for each of the registered locations.

7. A method for charging a battery of an autonomous driving vehicle equipped with a solar cell, the method for charging the battery comprising:
searching for a solar power generation point at which an amount of power for charging the battery is increased relative to a current location of the autonomous driving vehicle; and
moving the autonomous driving vehicle to the solar power generation point by autonomous driving.
